(19) United States
(12) Patent Application Publication
(10) Pub. No.: US 2010/0151208 A1
(43) Pub. Date: Jun. 17, 2010

(54) Sensing Clothing

(76) Inventor: Chien-Feng LIN, Jhonghe City (TW)

Correspondence Address: TROXELL LAW OFFICE PLLC;SUITE 1404, 5205 LEESBURG PIKE, FALLS CHURCH, VA, 22041, US

(21) Appl. No.: 12/334,473

(22) Filed: Dec. 14, 2008

(51) Int. Cl. B32B 3/10; B32B 3/00

(52) U.S. Cl. 428/172; 428/221; 428/196

(57) ABSTRACT

Sensing clothing of the present invention has a thermosensitive layer or a fluorescent layer and/or a photosensitive layer those can be disposed at appropriate positions of the outer skin layer of said clothing and can be coordinated and combined according to the requirements. Said photosensitive layer can sense different light intensities and generates an alarm signal if the intensity of the ultraviolet light is too high. Said thermosensitive layer has more than one arbitrary color and exhibits different colors as critical temperatures vary to show how high the temperature is. And said fluorescent layer absorbs light to emit light, which displays colors in a dark room or at night. These enhance the functionality and feel of the clothing, thus increasing the added value of the products.

### BACKGROUND OF THE INVENTION

(a) Field of the Invention

The present invention relates to clothing, and more particularly to clothing having a sensing color changing function.

(b) Description of the Prior Art

Clothing provides protection for the body from hazards and cold in the environment whereby modern people also often show their personal image as well as style and taste. No matter how the trend changes, technology progresses or the cultures of different regions differ, consumers always have demand for variations and design in clothing. From ancient times to the present, all brand manufacturers have been continuously developing new products to replace obsolete products so the market competition is very vigorous. The essentials for consumers to purchase clothing are not only centered on the practicability of protection from hazards and cold, but are also further centered on distinctive style and fashion design. Therefore, all famous brand manufacturers spare no effort in design without exception so as to find favor with the consumers.

However, some skilled persons now have designed the clothing to meet the duty requirements and security protection for some special workers and special populations. In order to meet the consumer psychology of new product adoption, practical clothing combined with the fashion trend can further bring more business opportunities.

### SUMMARY OF THE INVENTION

In view of the above-mentioned circumstances, a primary object of the present invention is to provide sensing clothing having a thermosensitive layer or a fluorescent layer and/or a photosensitive layer those can be disposed at appropriate positions of the outer skin layer of the clothing and can be coordinated and combined according to the requirements to enhance the functionality and feel of the clothing as well as increase the added value of the products.

To achieve the above objective, sensing clothing of the present invention can be provided with a thermosensitive layer or a fluorescent layer and/or a photosensitive layer, and the above three structural layers can be coordinated and combined according to the requirements. The key points are:

A photosensitive layer formed by using a photosensitizer is disposed at an appropriate position of the outer skin layer of said clothing. Said photosensitive layer is provided with more than one arbitrary color and exhibits different colors as light intensities vary, and said photosensitive layer can also sense different intensities of ultraviolet light;

A thermosensitive layer formed by using a thermosensitizer is disposed at an appropriate position of the outer skin layer of said clothing. The thermosensitive layer is provided with more than one arbitrary color and exhibits different colors as critical temperatures vary;

Further, a fluorescent layer formed by using a fluorescent agent can be disposed at an appropriate position of the outer skin layer of said clothing and said fluorescent layer emits light after the fluorescent agent absorbs light.

Said thermosensitive layer, fluorescent layer and photosensitive layer can be in the form of characters or totems or various patterns, and can also be made in three-dimensional form to further enhance the aesthetics of personal style and taste as well as the feel of brilliant styling besides imparting practicability and functionality to said clothing.

### BRIEF DESCRIPTION OF THE DRAWINGS

FIG. 1 is a schematic view showing the coating and deposition of a structure of sensing clothing according to the present invention.

FIG. 2 is a schematic view showing a piece of clothes to which sensing clothing according to the present invention is applicable.

FIG. 3 is a schematic view showing a pair of trousers to which sensing clothing according to the present invention is applicable.

FIG. 4 is a schematic view showing the coating and deposition of another structure of sensing clothing according to the present invention.

FIG. 5 is a schematic view showing a glove to which sensing clothing according to the present invention is applicable.

FIG. 6 is a schematic view showing a hat to which sensing clothing according to the present invention is applicable.

FIG. 7 is a schematic view showing the coating and deposition of another structure of sensing clothing according to the present invention.

FIG. 8 is a schematic view showing another pair of trousers to which sensing clothing according to the present invention is applicable.

FIG. 9 is a schematic view showing another piece of clothes to which sensing clothing according to the present invention is applicable.

### DETAILED DESCRIPTION OF THE PREFERRED EMBODIMENTS

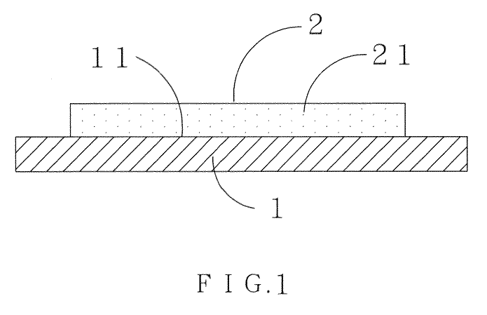

As illustrated in FIG. 1, sensing clothing of the present invention comprises clothing 1 and a photosensitive layer 2. The photosensitive layer 2 formed by using a photosensitizer 21 is disposed at an appropriate position of the outer skin layer 11 of said clothing 1. Said photosensitizer 21 is coated or adhered to form the photosensitive layer 2.

The key points of the present invention are: said photosensitive layer 2 senses light intensities, and the photosensitive layer 2 is provided with more than one arbitrary color and exhibits different colors as light intensities vary. Said photosensitive layer 2 can sense ultraviolet light.

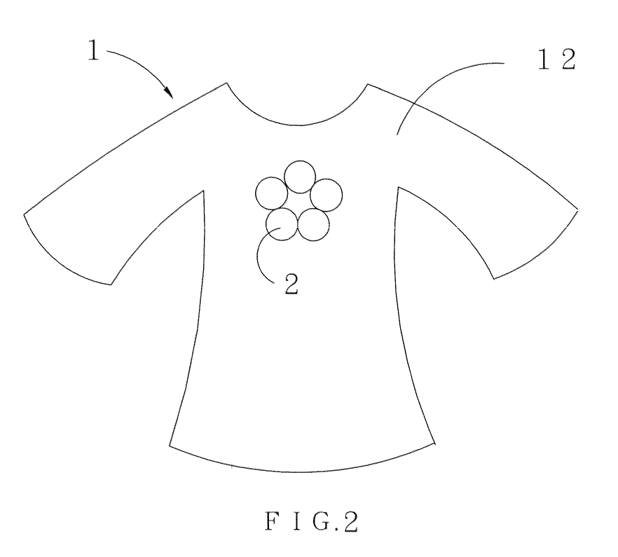

Accordingly, in the actual practice of the present invention, as shown in the first embodiment of FIG. 2, said clothing 1 is a piece of clothes 12, at an appropriate position of which is disposed a flower-shaped photosensitive layer 2. The photosensitive layer is disposed with five petals that are set with five colors and can sense different light intensities at five stages. When the intensity of the ultraviolet light is too high, an alarm signal is provided from the color display of said flower-shaped pattern.

The clothing 1 of the present invention can also be a pair of trousers 13, a skirt, a glove 14, a hat 15, a gauze mask or like articles. Said photosensitive layer 2 can also be formed in various patterns like characters or graphs, and can also be made in three-dimensional form.

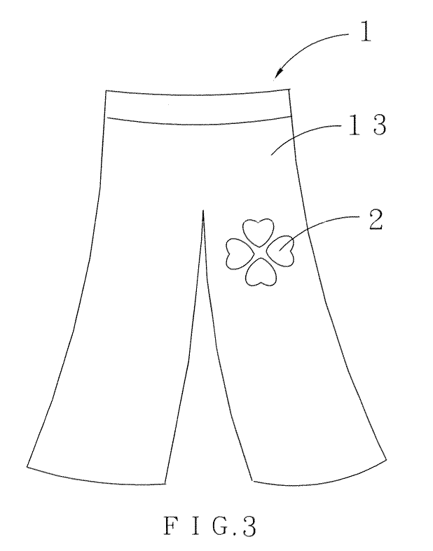

Further, as shown in the second embodiment of FIG. 3, said clothing is a pair of trousers 13, at appropriate positions of which are disposed four three-dimensional heart-embossed patterns that are photosensitive layers 2 of four arbitrary colors respectively and can sense different light intensities at four stages. When the intensity of the ultraviolet light is too high, an alarm signal is provided from the color display of said heart-shaped patterns.

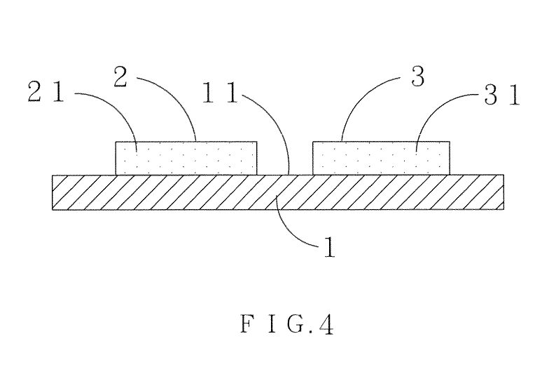

Moreover, as illustrated in FIG. 4, a photosensitive layer 2 formed by using a photosensitizer 21 is disposed at an appropriate position of the outer skin layer 11 of said clothing according to the present invention. The photosensitive layer 2 can sense light. Said photosensitizer 21 is coated or adhered to form the photosensitive layer 2. Meanwhile, a thermosensitive layer 3 formed by using a thermosensitizer 31 is disposed at an appropriate position of the outer skin layer 11 of said clothing 1. Said thermosensitive layer 3 senses temperature. Said thermosensitizer 31 is coated or adhered to form the thermosensitive layer 3. The key points are:

Said photosensitive layer 2 is provided with more than one arbitrary color and exhibits different colors as light intensities vary. Said photosensitive layer 2 can sense ultraviolet light. Said thermosensitive layer 3 is provided with more than one arbitrary color and exhibits different colors as critical temperatures vary.

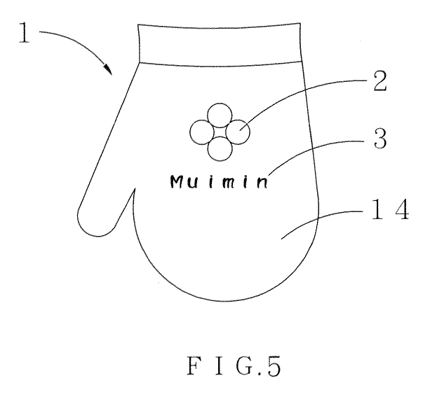

As shown in the third embodiment of FIG. 5, said clothing is a glove 14, at appropriate positions of which are disposed four circular photosensitive layers 2 that are of four arbitrary colors respectively and can sense different light intensities at four stages. Particularly, when the intensity of the ultraviolet light is too high, an alarm signal is obtained from the color display of the circular patterns. Meanwhile, thermosensitive layers 3 in the form of English characters are disposed at appropriate positions of said glove 14. The English characters are set with six arbitrary different colors and capable of sensing critical temperatures in six different ranges.

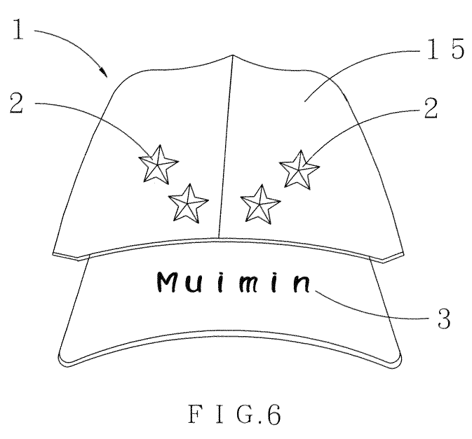

Further, as shown in the fourth embodiment of FIG. 6, said clothing is a hat 15, at appropriate positions of which are disposed four three-dimensional star-shaped photosensitive layers 2 of different respective colors and can sense different light intensities at four stages. At the same time, thermosensitive layers 3 in the form of English characters are disposed at appropriate positions of said hat 15. The English characters are set with six arbitrary different colors and capable of sensing critical temperatures in six different ranges.

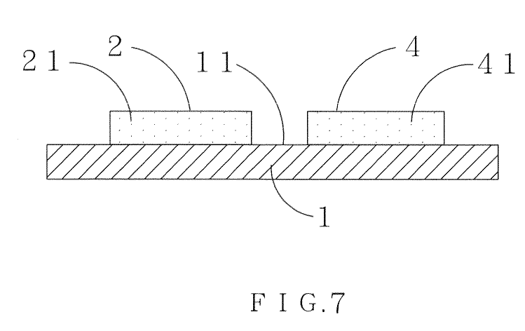

Moreover, as illustrated in FIG. 7, a photosensitive layer 2 formed by using a photosensitizer 21 is disposed at an appropriate position of the outer skin layer 11 of said clothing according to the present invention. The photosensitive layer 2 can sense light. Said photosensitizer 21 is coated or adhered to form the photosensitive layer 2. Meanwhile, a fluorescent layer 4 formed by using a fluorescent agent 41 is disposed at an appropriate position of the outer skin layer 11 of said clothing. Said fluorescent layer 4 emits light after the fluorescent agent 41 absorbs light. Said fluorescent agent 41 is coated or adhered to form the fluorescent layer 4. The key points are:

Said photosensitive layer 2 is provided with more than one arbitrary color and exhibits different colors as light intensities vary. Said photosensitive layer 2 can sense ultraviolet light. Said fluorescent layer 4 emits light after the fluorescent agent 41 absorbs light.

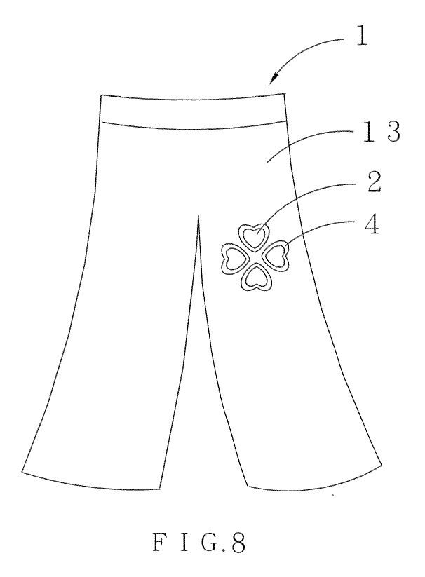

As shown in the fifth embodiment of FIG. 8, said clothing is a pair of trousers 13, at appropriate positions of which are disposed four heart-shaped photosensitive layers 2 of four arbitrary colors and can sense different light intensities at four stages. When the intensity of the ultraviolet light is too high, an alarm signal is generated from the color display of said heart-shaped patterns. Meanwhile, a fluorescent layer 4 is disposed around each of said heart-shaped patterns. After said fluorescent layer 4 absorbs light, said fluorescent layer 4 will emit light at night or in a dark room, thus obtaining the feel of brilliant styling.

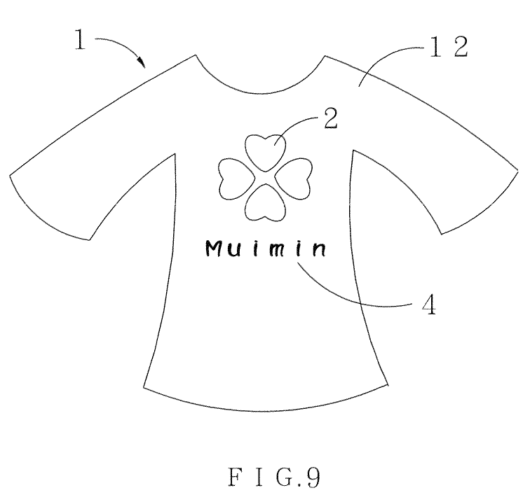

Furthermore, as shown in the sixth embodiment of FIG. 9, said clothing 1 is a piece of clothes 12, at appropriate positions of which are disposed heart-shaped photosensitive layers 2 of four arbitrary different colors and can sense different light intensities at four stages. At the same time, thermosensitive layers 3 in the form of English characters are disposed at appropriate positions of said piece of clothes 12. The English characters are set with six arbitrary different colors and capable of sensing critical temperatures in six different ranges.

As mentioned above, the prevent invention provides an improved structure of sensing clothing, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. Sensing clothing at least comprising:
clothing that has an outer skin layer; and
a photosensitive layer that is disposed at an appropriate position of said outer skin layer, said photosensitive layer being formed by using a photosensitizer, said photosensitive layer being provided with more than one arbitrary color and exhibiting different colors as light intensities vary.

2. The sensing clothing as described in claim 1, wherein said photosensitive layer is in the form of characters or symbols or graphs or three-dimensional patterns and is formed by coating is or adhesion.

3. The sensing clothing as described in claim 1, wherein said photosensitive layer is able to sense different intensities of ultraviolet light.

4. The sensing clothing as described in claim 1, wherein a thermosensitive layer formed by using a thermosensitizer is further disposed at an appropriate position of the outer skin layer of said clothing, and said thermosensitive layer is provided with more than one arbitrary color and exhibits different colors as critical temperatures vary.

5. The sensing clothing as described in claim 4, wherein said thermosensitive layer is in the form of characters or symbols or graphs or three-dimensional patterns and is formed by coating or adhesion.

6. The sensing clothing as described in claim 1, wherein a fluorescent layer formed by using a fluorescent agent is further disposed at an appropriate position of the outer skin layer of said clothing and said fluorescent layer emits light after the fluorescent agent absorbs light.

7. The sensing clothing as described in claim 6, wherein said fluorescent layer is in the form of characters or symbols or graphs or three-dimensional patterns and is formed by coating or adhesion.
